(19) United States
(12) Patent Application Publication
(10) Pub. No.: US 2026/0301204 A1
(43) Pub. Date: Oct. 1, 2026

(54) NEURAL RADIANCE FIELD TRAINING METHOD AND NEW VIEW IMAGE SYNTHESIS METHOD, DEVICE, AND STORAGE MEDIUM

(71) Applicant: HANGZHOU DIANZI UNIVERSITY, Hangzhou (CN)

(72) Inventors: Jiayi XU, Hangzhou (CN); Taoqi BAO, Hangzhou (CN)

(73) Assignee: HANGZHOU DIANZI UNIVERSITY, Hangzhou (CN)

(21) Appl. No.: 19/233,332

(22) Filed: Jun. 10, 2025

(30) Foreign Application Priority Data
Mar. 28, 2025 (CN) 202510388313.7

(51) Int. Cl. G06T 7/55; G06T 7/73

(52) U.S. Cl. CPC G06T 7/55; G06T 7/73

(57) ABSTRACT

A neural radiance field training method, a new view image synthesis method, a device, and a storage medium are provided. The neural radiance field training method includes: inputting a sparse view image to a depth-complement network, and acquiring a dense depth image which is output by the depth-complement network and corresponding to the sparse view image, monitoring a first stage training of a neural radiance field by the dense depth image, performing feature alignment on the first view image and the sparse view image to obtain a feature matrix, and monitoring a second stage training of the neural radiance field by the feature matrix.

### CROSS-REFERENCE TO RELATED APPLICATION

This application claims priority to Chinese patent application No. 202510388313.7, filed on Mar. 28, 2025, titled “NEURAL RADIANCE FIELD TRAINING METHOD AND NEW VIEW IMAGE SYNTHESIS METHOD, DEVICE, AND STORAGE MEDIUM”, the content of which is hereby incorporated herein in its entirety by reference.

### TECHNICAL FIELD

The present disclosure generally relates to the field of three-dimensional reconstruction, and in particular, to a neural radiance field training method, a new view image synthesis method, a device, and a storage medium.

### BACKGROUND

In the field of deep learning and computer vision, Neural Radiance Field (NeRF) technology has become a powerful 3D scene representation and a new view combination tool. In an optimization aspect, such as optimization of a training speed, a rendering speed, rendering quality, few views or single view reconstruction, any camera-path reconstruction, dynamic NeRF, Diffusion 3D, point cloud reconstruction, and the like, extremely exciting results are displayed. However, when the NeRF faces a small number of input views, it is often difficult to accurately reconstruct a geometry and an appearance of the scene due to insufficient constraints imposed by a volume rendering loss alone, and there is a large number of “Floaters” concentrated on a camera surface. In some complex environments, such as disaster sites, hard-to-reach regions, or protected cultural heritage sites, it is very difficult or expensive to acquire dense views. In the field of medical imaging, for example, X-ray or CT scanning, in order to reduce radiation exposure to a patient, the quantity of imaging times needs to be reduced as much as possible. During security check, such as airport security check, fast and effective scanning is required without interfering with normal processes. In an autonomous vehicle, it may not be ensured that complete view data can be obtained in all cases. Therefore, complete scene information needs to be deduced from limited views.

A difficulty of sparse view reconstruction is that data sparsity limits a comprehensive understanding of the scene, and at the same time, it is a difficulty to maintain a sense of truth and details similar to an original scene when a new view is synthesized. As an important constraint condition, geometric consistency helps to improve robustness of an algorithm, reduce impact of error matching and noise, and helps to recover a more accurate and complete three-dimensional structure from sparse views. Therefore, a considerable portion of the sparse view reconstruction studies focus on how to improve the geometric consistency of the scene better.

For an issue of lack of geometric consistency in a process of NeRF sparse image reconstruction in the related art, no effective solution is proposed.

### SUMMARY

According to various embodiments of the present disclosure, a neural radiance field training method, a new view image synthesis method, a device, and a storage medium are provided.

In a first aspect, a neural radiance field training method is provided in the present disclosure. The method includes: inputting a sparse view image to a depth-complement network, and acquiring a dense depth image which is output by the depth-complement network and corresponding to the sparse view image, monitoring a first stage training of a neural radiance field by the dense depth image, performing feature alignment on the first view image and the sparse view image to acquire a feature matrix, and monitoring a second stage training of the neural radiance field by the feature matrix. An input of the first stage training of the neural radiance field is the sparse view image, and an output of the first stage training of the neural radiance field is a first view image. An input of the second stage training of the neural radiance field is the sparse view image and the first view image, and an output of the second stage training of the neural radiance field is a second view image.

In some embodiments, inputting the sparse view image to the depth-complement network further includes: acquiring a sparse depth image of the sparse view image according to the sparse view image, and inputting the sparse view image and the sparse depth image to the depth-complement network.

In some embodiments, the depth-complement network includes a convolutional neural network and a vision transformer.

In some embodiments, the depth-complement network includes an encoder and a decoder, and inputting the sparse view image into the depth-complement network and acquiring the dense depth image corresponding to the sparse view image that is output by the depth-complement network further includes: encoding the sparse view image and the sparse depth image in the encoder by a first convolution layer of a convolutional neural network to acquire an original feature embedding, in which the original feature embedding includes color and depth; inputting the original feature embedding to a residual block and a JCAT block which are consecutive to acquire a converter path and a convolution path, in which the JCAT block is coupled to a convolution attention layer and a vision transformer of the convolution neural network; fusing the converter path and the convolution path by a second convolution layer of the convolution neural network, so as to obtain a feature diagram output by the encoder; and performing up sampling on the feature diagram by the decoder, and fusing an up-sampled feature with a feature of a prediction header of the depth-complement network, and obtaining the dense depth image.

In some embodiments, fusing the up-sampled feature with the feature of the prediction header of the depth-complement network, so as to obtain the dense depth image further includes: fusing the up-sampled feature with the feature of the prediction header of the depth-complement network, so as to obtain an initial depth image; and dividing the initial depth image into depth image blocks, performing information compensation between non-adjacent depth image blocks by an SPN model, and acquiring the dense depth image according to the compensated depth image blocks.

In some embodiments, performing feature alignment on the first view image and the sparse view image to acquire the feature matrix further includes: inputting the first view image and the sparse view image to a pre-trained feature extraction and matching network, extracting a matched coordinate point and a corresponding color value, and combining the matched coordinate point and the corresponding color value into the feature matrix.

In some embodiments, a loss function of the neural radiance field includes at least one of a color loss function, a depth loss function, or a feature-match loss function.

In some embodiments, the color loss function is configured to acquire a pixel error between the second view image and the sparse view image, the depth loss function is configured to acquire a difference between a depth value of the second view image and a depth value of the dense depth image, and the feature-match loss function is configured to acquire a difference between a color value of a feature point in the second view image and a color value obtained by querying a coordinate corresponding to the feature point from the feature matrix.

In a second aspect, a new view image synthesis method is further provided in the present disclosure. The new view image synthesis method includes: acquiring a target sparse view image, and inputting the target sparse view image to a neural radiance field which is trained by the above neural radiance field training method, so as to acquire a new view image.

In a third aspect, a computer program product is further provided in the present disclosure, which includes a computer program. The computer program is executed by a processor to implement the neural radiance field training method in the first aspect or the new view image synthesis method in the second aspect.

In a fourth aspect, a computer-readable storage medium is further provided in the present disclosure, storing a computer program. The computer program is executed by a processor to implement the neural radiance field training method in the first aspect or the new view image synthesis method in the second aspect.

Details of one or more embodiments of the present disclosure are proposed in the following accompanying drawings and descriptions, so that other features, objects, and advantages of the present disclosure are more easily understood.

### BRIEF DESCRIPTION OF THE DRAWINGS

In order to more clearly illustrate the technical solutions in the embodiments of the present disclosure or the related technology, the accompanying drawings to be used in the description of the embodiments or the related technology will be briefly introduced below, and it will be obvious that the accompanying drawings in the following description are only some of the embodiments of the present disclosure, and that, for one skilled in the art, other accompanying drawings can be obtained based on these accompanying drawings without putting in creative labor.

FIG. 1 is a block diagram of a hardware structure of a terminal that applies a neural radiance field training method in an embodiment of the present disclosure.

FIG. 2 is a flowchart of a neural radiance field training method in an embodiment of the present disclosure.

FIG. 3 is a specific flowchart of a neural radiance field training method in an embodiment of the present disclosure.

FIG. 4 is a flowchart of acquiring a dense depth image in an embodiment of the present disclosure.

FIG. 5 is a flowchart of acquiring a feature matrix in an embodiment of the present disclosure.

FIG. 6 is a schematic diagram of a computer device in an embodiment of the present disclosure.

### DETAILED DESCRIPTION OF THE EMBODIMENT

The following clearly and completely describes the technical solutions in the embodiments of the present disclosure with reference to the accompanying drawings in the embodiments of the present disclosure. Apparently, the described embodiments are merely some rather than all of the embodiments of the present disclosure. Based on the embodiments of the present disclosure, all other embodiments obtained by one skilled in the art without creative efforts fall within the protection scope of the present disclosure.

Unless otherwise defined, all technical and scientific terms used herein have the same meaning as one skilled in the art would understand. The terms “one”, “a”, “an”, “the”, “this”, and other similar words as used in the present disclosure do not indicate quantitative limitations, and they can be singular or plural. The terms “include”, “comprise”, “have”, and any variation thereof, as used in the present disclosure, are intended to cover a non-exclusive inclusion. For example, processes, methods, products, or devices including a series of steps or modules (units) are not limited to listed steps or units, but may include steps or units not listed, or may include other steps or units inherent in those processes, methods, products, or devices. The terms “connection”, “connected”, “coupling”, and other similar words as used in the present disclosure are not limited to physical or mechanical connections, but may include electrical connections, which can be direct connections or indirect connections. The term “plurality” in the present disclosure refers to two or more. “And/or” describes an association relationship between associated objects, indicating that there can be three kinds of relationships. For example, “A and/or B” can mean that A exists alone, A and B exist at the same time, and B exists alone. The character “/” indicates that the objects associated with each other are in an “or” relationship. The terms “first”, “second”, “third”, etc. involved in the present disclosure are only configured for distinguishing similar objects, and do not represent a specific order of the objects.

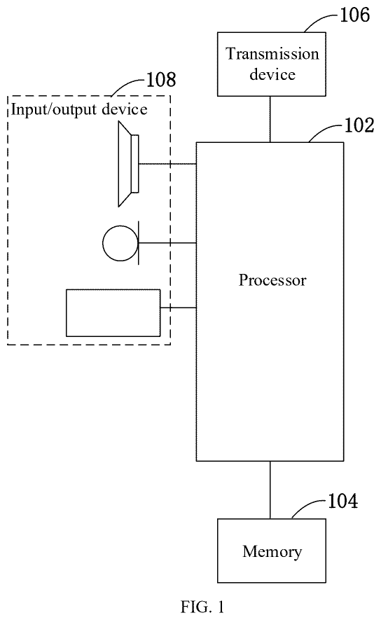

A method provided in the present disclosure may be executed in a terminal, a computer, or a similar computer device. As an example of running on a terminal, FIG. 1 is a block diagram of a hardware structure of a terminal that applies a neural radiance field training method in an embodiment of the present disclosure. Referring to FIG. 1, a terminal may include one or more processors 102 (only one is shown in FIG. 1) and a memory 104 configured for storing data. The processor 102 may include, but is not limited to, a processing device such as a Microcontroller Unit (MCU), or a Field Programmable Gate Array (FPGA). The terminal may further include a transmission device 106 configured for communication functions and an input and output device 108. One skilled in the art may understand that the structure shown in FIG. 1 is only schematic, and it does not limit the structure of the terminal. For example, the terminal may also include more or fewer components than that shown in FIG. 1, or has a different configuration from that shown in FIG. 1.

The memory 104 may be configured to store a computer program, such as a software program and module of application software. For example, the computer program corresponding to the neural radiance field training method in an embodiment of the present disclosure may be stored in the memory 104. The computer program stored in the memory 104 may be executed by the processor 102 to perform various functional applications as well as data processing, i.e., to implement the above neural radiance field training method. The memory 104 may include a high-speed random memory, and may also include a non-volatile memory such as one or more magnetic storage devices, flash memories, or other non-volatile solid-state memories. In some embodiments, the memory 104 may further include memories that are remotely located relative to the processor 102, and these remote memories may be connected to the terminal via a network. Examples of the above network may include, but are not limited to, the Internet, a corporate intranet, a local area network, a mobile communication network, and combinations thereof.

The transmission device 106 is configured to receive or send data via a network. Specific examples of the described network may include a wireless network provided by a communication provider of the terminal. In an embodiment, the transmission device 106 may include a network interface controller (NIC) that may be connected to other network devices via a base station to communicate with the Internet. In an embodiment, the transmission device 106 may include a Radio Frequency (RF) module, which is configured to communicate with the Internet in a wireless manner.

The above terminal, computer, or similar operation apparatus is also applicable to a new view image synthesis method in the present disclosure.

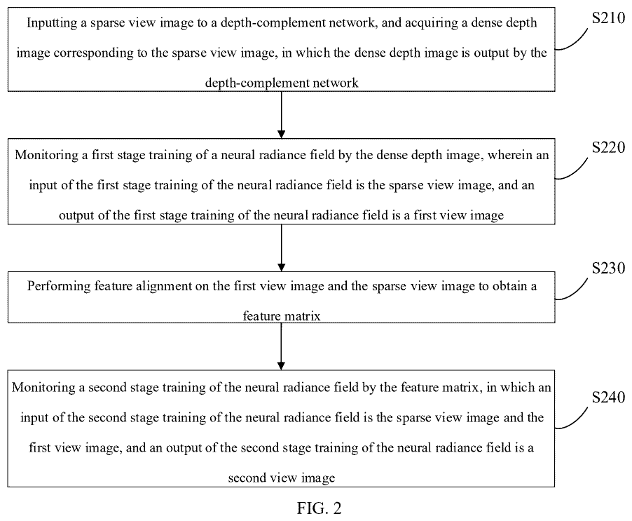

A neural radiance field training method is provided in the present disclosure. FIG. 2 is a flowchart of a neural radiance field training method in an embodiment of the present disclosure. Referring to FIG. 2, the neural radiance field training method includes step 210 to step 240.

Step 210 includes inputting a sparse view image to a depth-complement network, and acquiring a dense depth image which is output by the depth-complement network and corresponding to the sparse view image.

At step 210, the sparse view image may include a few view images taken on a specific scene. These views of the view images may be different from each other, and the specific quantity of the views may be determined according to an actual requirement. A depth-complement network may be a computer vision model based on depth learning, and mainly configured to capture a global feature and a geometric relationship of the scene and generate the dense depth image that is generally consistent with an input image.

It should be noted that the sparse view image may include a color image, a black-and-white image, a grayscale image, or the like, and may include an actually photographed image or a virtual scene image.

Step 220 includes monitoring a first stage training of a neural radiance field by the dense depth image. An input of the first stage training of the neural radiance field is the sparse view image, and an output of the first stage training of the neural radiance field is a first view image.

At step 220, the neural radiance field may include a fully connected neural network, and a complex 3D scene view image may be generated based on partial 2D images. The principle may be that a rendering loss function is used to train a network to reproduce a view of the scene. The input (i.e., training samples) of the first stage training of the neural radiance field is the sparse view image, and the output of the first stage training of the neural radiance field is the first view image. The first view image may have a preliminary three-dimensional scene (expressed by the neural radiance field). The first stage training of the neural radiance field is monitored by the dense depth image, so that low-frequency information of the image, such as a geometric shape of the scene, may be maintained well, thereby ensuring geometric consistency.

Step 230 includes performing feature alignment on the first view image and the sparse view image to acquire a feature matrix.

At step 230, a view of the first view image may be different from a view of the sparse view image, and there are some same pixels between the first view image and the sparse view image. Features of these pixels in the first view image may be corresponding to features of these pixels in the sparse view image, and the corresponding feature matrix may be obtained by the feature alignment, so as to provide a data basis for acquiring high-frequency information of the image.

Furthermore, an element of the feature matrix may include a coordinate point, a color value, or the like.

Step 240 includes monitoring a second stage training of the neural radiance field by the feature matrix. An input of the second stage training of the neural radiance field is the sparse view image and the first view image, and an output of the second stage training of the neural radiance field is a second view image.

At step 240, the input of the second stage training of the neural radiance field is the sparse view image and the first view image, and the output of the second stage training of the neural radiance field is the second view image. By means of monitoring by using a feature matrix, the second viewing angle image has both low-frequency information and high-frequency information of the image, and may be an image that is expressed in a three-dimensional scenario and any viewing angle.

In the present embodiment, the dense depth image is obtained by the depth-complement network, and the first stage training of the neural radiance field is monitored by using the dense depth image, so that the first view image obtained by the neural radiance field may not only have geometric consistency, but also eliminate artifacts caused by a depth information error. In addition, feature extraction and matching may be performed on the first view image and the sparse view image to acquire the feature matrix, and the second stage training of the neural radiance field is monitored by using the feature matrix, so that the second view image may have both low-frequency information and high-frequency information, and include textures and details in the sparse view image, and image information may be more accurate.

Furthermore, the sparse view image may include a group of images with a few views. When the feature alignment is performed on the first view image and the sparse view image, one sparse view image whose view is adjacent to that of the first view image may be selected from the group of images for feature alignment.

In some embodiments, inputting the sparse view image to the depth-complement network may further include: acquiring a sparse depth image of the sparse view image according to the sparse view image, and inputting the sparse view image and the sparse depth image to the depth-complement network.

In the present embodiment, the sparse depth image of the sparse view image may be obtained first, and the sparse view image and the sparse depth image may be input to the depth-complement network, so that the depth-complement network may output an accurate dense depth image.

Furthermore, acquiring the sparse depth image of the sparse view image according to the sparse view image may further include: acquiring the sparse depth image of the sparse view image by a SFM (structure from motion) method. The SFM method may restore a three-dimensional structure of the scene by matching feature points in multiple view images, so as to obtain a corresponding sparse depth image.

In some embodiments, the depth-complement network may include a convolutional neural network and a vision transformer.

In the present embodiment, the depth-complement network may combine the convolutional neural network (CNN) with the vision transformer (ViT). The convolutional neural network may help accurately focus on important features in a local range and inhibit unnecessary features. The vision transformer may combine global context information of each pixel of the image with a self-attention mechanism. In this way, an accurate dense depth image may be obtained.

Furthermore, the depth-complement network may be based on a U-NET architecture and may include an encoder and a decoder. Inputting the sparse view image into the depth-complement network, and acquiring the dense depth image corresponding to the sparse view image that is output by the depth-complement network may further include: encoding the sparse view image and the sparse depth map in the encoder by a first convolution layer of a convolutional neural network to acquire an original feature embedding, in which the original feature embedding includes color and depth; inputting the original feature embedding to a residual block and a JCAT (Joint Convolutional Attention and Transformer) block which are consecutive to acquire a converter path and a convolution path, in which the JCAT block is coupled to a convolution attention layer and a vision transformer of the convolution neural network; fusing the converter path and the convolution path by a second convolution layer of the convolution neural network, so as to obtain a feature diagram output by the encoder; and performing up sampling on the feature diagram by the decoder, and fusing an up-sampled feature with a feature of a prediction header of the depth-complement network, and obtaining the dense depth image.

In the present embodiment, the dense depth image that is generally consistent with the input image may be generated by the processing of the depth-complement network.

It should be noted that the depth-complement network may obtain a predicted image by the prediction header. The prediction header may be a module in the depth-complement network, which is configured to extract an image feature from an image input to the depth-complement network. The image feature may be the feature of the prediction header.

Furthermore, fusing the up-sampled feature with the feature of the prediction header of the depth-complement network, so as to obtain the dense depth image may further include: fusing the up-sampled feature with the feature of the prediction header of the depth-complement network, so as to obtain an initial depth image; and dividing the initial depth image into depth image blocks, performing information compensation between non-adjacent depth image blocks by a SPN (Sum-Product Networks) model, and acquiring the dense depth image according to the compensated depth image blocks.

In the present embodiment, by information compensation of the SPN model, the generated dense depth image may be more accurate.

In some embodiments, performing feature alignment on the first view image and the sparse view image to acquire the feature matrix may further include: inputting the first view image and the sparse view image to a pre-trained feature extraction and matching network, extracting a matched coordinate point and a corresponding color value, and combining the matched coordinate point and the corresponding color value into the feature matrix.

In the present embodiment, a feature matching relationship between the first view image and the sparse view image may be extracted quickly by the pre-trained feature extraction and matching network, and the matched coordinate point and the corresponding color value may be combined into the feature matrix. The feature matrix may represent high-frequency information of the sparse view image, and be configured to monitor generation of the second view image by the neural radiance field, so as to enhance performance of the second view image in aspects such as texture and edge sharpness.

It should be noted that the feature extraction and matching network may include SuperGlue, LoFTR (Local Feature Transformer), DKM (Dense Kernelized Feature Matching), or the like.

In some embodiments, a loss function of the neural radiance field may include at least one of a color loss function, a depth loss function, or a feature-match loss function.

In the present embodiment, the loss function of the neural radiance field may include at least one of the color loss function, the depth loss function, or the feature-match loss function. The loss functions may balance effects of a low-frequency geometric feature and a high-frequency detail feature on training.

Specifically, the color loss function is configured to acquire a pixel error between the second view image and the sparse view image, so as to ensure pixel-level color accuracy. The depth loss function is configured to acquire a difference between a depth value of the second view image and a depth value of the dense depth image, so as to ensure geometric quality of the scene. The feature-match loss function is configured to acquire a difference between a color value of a feature point in the second view image and a color value obtained by querying a coordinate corresponding to the feature point from of the feature matrix, so as to ensure a restoration of high-frequency details.

In a specific embodiment, for the issue of lack of geometric consistency of neighboring views during a NeRF sparse reconstruction process, a low-frequency feature enhancement network with a depth complement function may be constructed. With reference to a dependency relationship between a local image feature in the scene and a long-distance image block, a relatively accurate dense depth image may be restored according to sparse depth information estimated initially to monitor scene reconstruction, so as to obtain an image with any view in 360 degrees. False artifacts caused by a depth error may be eliminated while basic information such as scene geometry may be restored. To solve a problem that high-frequency information such as details are easily lost during scene reconstruction, a high-frequency feature enhancement network based on a GIM (Generalized Image Matching) self-training policy may be proposed. A training image (existing sparse view image) may be used to extract and match a dense feature from a first view image reconstructed by the low-frequency feature enhancement network, and a detailed feature included in the training image may be supplemented to a reconstructed second view image.

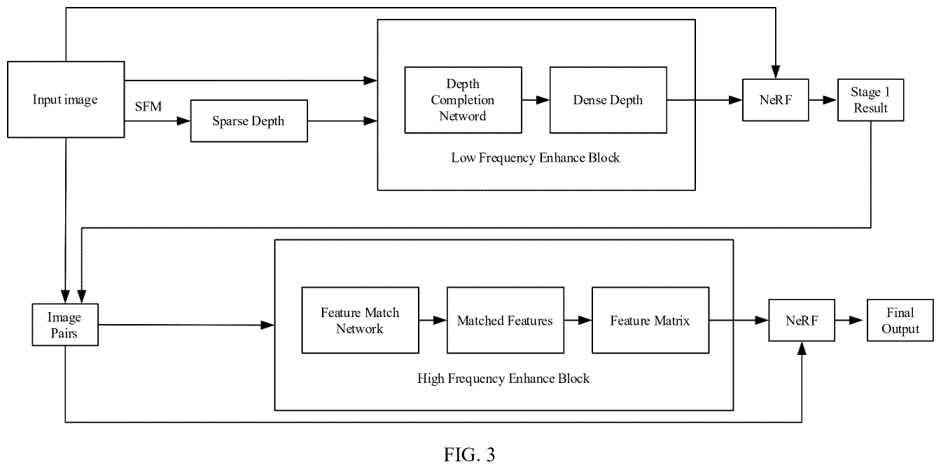

Furthermore, referring to FIG. 3, a group of color images with sparse views (which may be actually photographed or may include a virtual scene) may be used as training data to output a three-dimensional scene represented by a neural radiance field and a (new view) color image in any view. The whole training process may go through two stages: In a first stage, a depth-complement network combined with CNN and ViT may be designed, and the network may combine a sparse view image and a sparse depth image calculated by a SFM method as input to complete a corresponding dense depth image. Then the dense depth image may be used to monitor the training of NeRF and obtain a preliminary three-dimensional scene (expressed by the neural radiance field) and a new view image. It is found from an experiment that a result of the first stage may maintain low-frequency information such as a geometric shape of the scene, but features such as a texture on a surface of an object may not natural enough. In a second stage, for the new view image generated in the first stage, an input training image whose view is adjacent to that of the new view image may be searched, a pre-trained feature extraction and matching network (e.g., SuperGlue, LoFTR, and DKM) may be used for feature extraction and matching to matched images, the matched features may be combined into a feature matrix, further training may be performed on the neural radiance field obtained in the first stage, and finally an image in any view that has three-dimensional scene representation including low-frequency information and high-frequency information may be obtained.

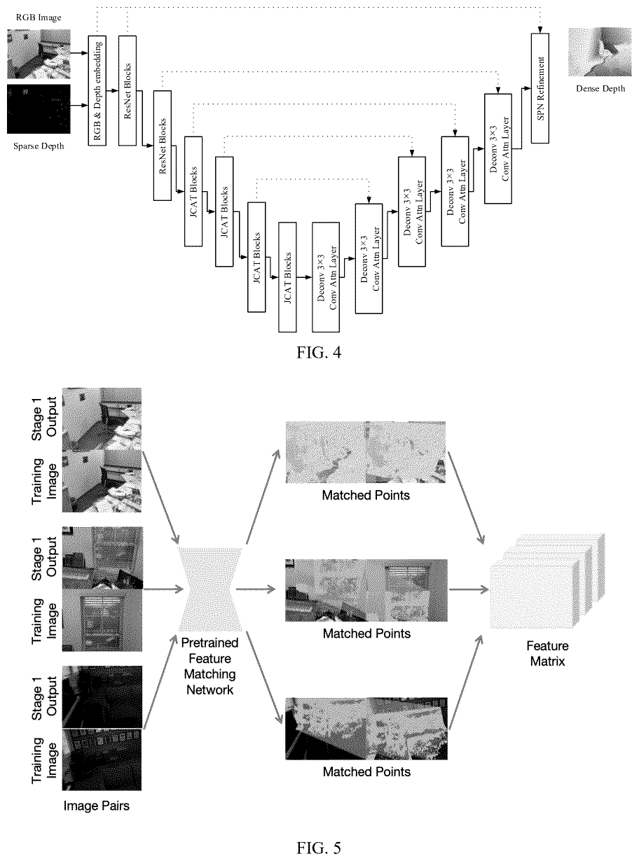

In the first stage, the sparse depth information of the corresponding color image may be estimated based on the SFM method first. Referring to FIG. 4, a depth-complement network may be based on a U-Net architecture and include an encoder and a decoder. The encoder may encode an input RGB image and an input sparse depth image by two independent convolutional layers, respectively, serially original feature embedding containing color and depth may be input to two residual blocks (ResNetBlock) and four JCAT (Joint Convolutional Attention and Transformer) blocks which are consecutive. The JCAT blocks may couple the convolutional attention layer to the Vision Transformer deeply. A Transformer layer may use a SRA (spatial-reduction attention) layer and a FNN (feedforward neural network) to combine the global context information of each pixel through the self-attention mechanism, and the convolutional attention layer may enhance a representation capability of a convolutional path by spatial and channel attention, so as to help the model accurately focus on important features within a local range and suppress unnecessary information. Finally, a feature fusion may connect features of a Transformer path to features of the convolutional path and fuse features by 3×3 convolutional layers. The decoder may connect outputs of encoding layers, further process of the outputs of the encoding layers may be performed by corresponding decoding layers, and a hop connection may be used to fuse features of different scales. Up sampling may be performed on a feature diagram output from the encoder, and an up-sampled feature may be fused with a feature of a prediction head to obtain a dense depth image which is initially predicted. The dense depth image may be divided into local image blocks, and information compensation may be performed between non-adjacent depth image blocks by a SPN model, so as to capture depth information with further distance and obtain a more accurate dense depth image. Based on the color image and the dense depth, a preliminary three-dimensional scene representation and a generated image in any view may be obtained according to a volume rendering process.

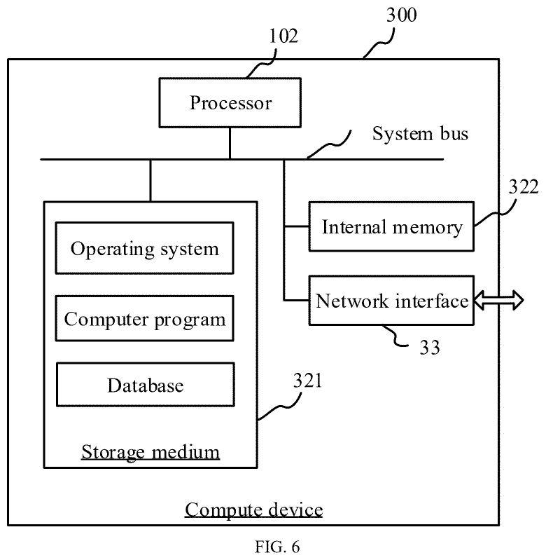

Referring to FIG. 5, in a second stage, the input training image whose view is adjacent to that of the new view image may be searched according to the view image generated in the first phase, a feature matching relationship between multiple groups of image pairs may be obtained by the pre-trained feature extraction and matching network (such as SuperGlue, LoFTR, and DKM), and a matched coordinate point and a corresponding color value may be integrated into the feature matrix. The training of NeRF in the second stage may be performed by using the input training image and images with multiple views generated in the first stage, and details may be monitored by the feature matrix, and a three-dimensional scene may be obtained in which texture details of an object surface are clearer.

It is considered that impact of color, depth, and feature matching on network training, the overall loss function L may be as follows:

$$L = {L}_{color} + {λ}_{depth} {L}_{depth} + {λ}_{feature \_ match} {L}_{feature \_ match}$$

$${L}_{depth} = {‖ {Z}_{i}^{NeRF} - {Z}_{i}^{dense} ‖}_{2}^{2}$$

$${L}_{feature \_ match} = {‖ {C}_{j} - {V}_{j} ( {L}_{j} ) ‖}_{2}^{2}$$

The color loss function Lcolor may calculate a pixel-by-pixel error between the generated new view image and a real value. The depth loss function Ldepth may calculate a difference between a depth value Zᵢ^{NeRF} obtained based on NeRF training and a dense depth value Zᵢ^{dense} obtained based on the depth-complement network, and λ_{depth} may be a corresponding weighting coefficient. The feature-match loss function L_{feature_match} may calculate a difference between a color value Cⱼ of a feature point in the generated new angle image and a color value Vⱼ (Lⱼ) that is queried from the feature matrix by a coordinate corresponding to the feature point, and λ_{feature_match} may be a corresponding weight coefficient.

A new view image synthesis method is further provided in the present disclosure. The new view image synthesis method includes: acquiring a target sparse view image, and inputting the target sparse view image to a neural radiance field which is trained by the above neural radiance field training method, so as to acquire a new view image.

In the present embodiment, a neural radiance field trained by the neural radiance field training method may be used to obtain a new view image according to the target sparse view image. The new view image may be an image in any view with three-dimensional scene representation of low-frequency information and high-frequency information of the image, have geometric consistency with the target sparse view image, and include texture and detail features in the target sparse view image.

It should be understood by one skilled in the art that the foregoing steps of the present disclosure may be implemented by a general computing apparatus. The steps may be concentrated on a single computing apparatus or distributed on a network formed by multiple computing apparatuses. Alternatively, the steps may be implemented by program code executable by the computing apparatus. Therefore, the program code may be stored in the storage apparatus and executed by the computing apparatus. In some cases, the steps shown or described may be executed in an order different from herein, or the steps may be separately fabricated into modules, or multiple components in the multiple computing apparatuses may be fabricated into a single module for implementation. In this way, the present disclosure is not limited to any specific combination of hardware and software.

The present disclosure further provides a computer device 300. The computer device 300 may be a server. FIG. 6 is a schematic diagram of a computer device in an embodiment of the present disclosure. Referring to FIG. 6, the computer device 300 includes a processor 102, a memory, and a network interface 33 that are connected by a system bus. The processor 102 of the computer device is configured to provide a computing and control capability. The memory of the computer device may include a storage medium 321 and an internal memory 322. The storage medium 321 may store an operating system, a computer program, and a database. The internal storage 322 may provide an environment for running an operating system and a computer program in the storage medium 321. The network interface 33 of the computer device is configured to communicate with an external terminal by a network connection. The computer program may be executed by the processor 102 to implement the neural radiance field training method or a new view image synthesis method.

One skilled in the art may understand that the structure shown in FIG. 6 is merely a block diagram of some structures related to the solutions of the present disclosure, and does not constitute a limitation on a computer device to which the solutions of the present disclosure are applied. A specific computer device may include more or fewer components than those shown in the figure, or combine some components, or have different component arrangements.

In addition, with reference to the neural radiance field training method or the new view image synthesis method in the foregoing embodiment, a storage medium 321 is further provided in the present disclosure. The storage medium 321 stores a computer program. When the computer program is executed by a processor, any one of the neural radiance field training methods or the new view image synthesis methods in the foregoing embodiments is implemented.

One skilled in the art may understand that all or a part of the processes in the methods in the foregoing embodiments may be implemented by a computer program instructing related hardware. The computer program may be stored in a non-volatile computer readable storage medium. When the computer program is executed, the processes in the foregoing methods embodiments may be included. Any reference to a memory, a database, or other medium used in the embodiments provided in the present disclosure may include at least one of a non-volatile memory or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As an illustration and not a limitation, the RAM may be obtained in multiple forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous link (Synch link) DRAM (SLDRAM), a memory bus (Rambus) direct RAM (RDRAM), a direct memory bus dynamic RAM (DRDRAM), and a memory bus dynamic RAM (RDRAM).

All the technical features in the foregoing embodiments may be any combination. To make the description brief, all possible combinations of the technical features in the foregoing embodiments are not described. However, as long as there is no contradiction between the combinations of the technical features, it should be considered as the scope described in this specification.

The foregoing embodiments represent only several implementation manners of the present disclosure, and descriptions thereof are relatively specific and detailed, but may not be construed as a limitation on the scope of the present disclosure. It should be noted that one skilled in the art may make some modifications and improvements without departing from the concept of the present disclosure, which are within the protection scope of the present disclosure. Therefore, the protection scope of the present disclosure shall be subject to the attached claims.

What is claimed is:

1. A neural radiance field training method, comprising:
inputting a sparse view image to a depth-complement network, and acquiring a dense depth image corresponding to the sparse view image, wherein the dense depth image is output by the depth-complement network;
monitoring a first stage training of a neural radiance field by the dense depth image, wherein an input of the first stage training of the neural radiance field is the sparse view image, and an output of the first stage training of the neural radiance field is a first view image;
performing feature alignment on the first view image and the sparse view image to acquire a feature matrix; and
monitoring a second stage training of the neural radiance field by the feature matrix, wherein an input of the second stage training of the neural radiance field is the sparse view image and the first view image, and an output of the second stage training of the neural radiance field is a second view image.

2. The neural radiance field training method of claim 1, wherein inputting the sparse view image to the depth-complement network further comprises:
acquiring a sparse depth image of the sparse view image according to the sparse view image, and inputting the sparse view image and the sparse depth image to the depth-complement network.

3. The neural radiance field training method of claim 1, wherein the depth-complement network comprises a convolutional neural network and a vision transformer.

4. The neural radiance field training method of claim 2, wherein the depth-complement network comprises an encoder and a decoder, and inputting the sparse view image into the depth-complement network and acquiring the dense depth image corresponding to the sparse view image that is output by the depth-complement network further comprises:
encoding the sparse view image and the sparse depth image in the encoder by a first convolution layer of a convolutional neural network to acquire an original feature embedding, wherein the original feature embedding comprises color and depth;
inputting the original feature embedding to a residual block and a Joint Convolutional Attention and Transformer block which are consecutive to acquire a converter path and a convolution path, wherein the Joint Convolutional Attention and Transformer block is coupled to a convolution attention layer and a vision transformer of the convolution neural network;
fusing the converter path and the convolution path by a second convolution layer of the convolution neural network, so as to obtain a feature diagram output by the encoder; and
performing up sampling on the feature diagram by the decoder, and fusing an up-sampled feature with a feature of a prediction header of the depth-complement network, and obtaining the dense depth image.

5. The neural radiance field training method of claim 4, wherein fusing the up-sampled feature with the feature of the prediction header of the depth-complement network, so as to obtain the dense depth image further comprises:
fusing the up-sampled feature with the feature of the prediction header of the depth-complement network, so as to obtain an initial depth image; and
dividing the initial depth image into depth image blocks, performing information compensation between non-adjacent depth image blocks by a Sum-Product Networks model, and acquiring the dense depth image according to the compensated depth image blocks.

6. The neural radiance field training method of claim 1, wherein performing feature alignment on the first view image and the sparse view image to acquire the feature matrix further comprises:
inputting the first view image and the sparse view image to a pre-trained feature extraction and matching network, extracting a matched coordinate point and a corresponding color value, and combining the matched coordinate point and the corresponding color value into the feature matrix.

7. The neural radiance field training method of claim 1, wherein a loss function of the neural radiance field comprises at least one of a color loss function, a depth loss function, or a feature-match loss function.

8. The neural radiance field training method of claim 7, wherein the color loss function is configured to acquire a pixel error between the second view image and the sparse view image, the depth loss function is configured to acquire a difference between a depth value of the second view image and a depth value of the dense depth image, and the feature-match loss function is configured to acquire a difference between a color value of a feature point in the second view image and a color value obtained by querying a coordinate corresponding to the feature point from the feature matrix.

9. A new view image synthesis method, comprising:
acquiring a target sparse view image, and inputting the target sparse view image to a neural radiance field which is trained by the neural radiance field training method of claim 1, so as to acquire a new view image.

10. A computer device, comprising a memory and a processor, wherein a computer program is stored in the memory, and the processor is configured to execute the computer program to implement the neural radiance field training method of claim 1.

11. The computer device of claim 10, wherein inputting the sparse view image to the depth-complement network further comprises:
acquiring a sparse depth image of the sparse view image according to the sparse view image, and inputting the sparse view image and the sparse depth image to the depth-complement network.

12. The computer device of claim 10, wherein the depth-complement network comprises a convolutional neural network and a vision transformer.

13. The computer device of claim 11, wherein the depth-complement network comprises an encoder and a decoder, and inputting the sparse view image into the depth-complement network and acquiring the dense depth image corresponding to the sparse view image that is output by the depth-complement network further comprises:
encoding the sparse view image and the sparse depth image in the encoder by a first convolution layer of a convolutional neural network to acquire an original feature embedding, wherein the original feature embedding comprises color and depth;
inputting the original feature embedding to a residual block and a Joint Convolutional Attention and Transformer block which are consecutive to acquire a converter path and a convolution path, wherein the Joint Convolutional Attention and Transformer block is coupled to a convolution attention layer and a vision transformer of the convolution neural network.

14. The computer device of claim 13, wherein fusing the up-sampled feature with the feature of the prediction header of the depth-complement network, so as to obtain the dense depth image further comprises:
fusing the up-sampled feature with the feature of the prediction header of the depth-complement network, so as to obtain an initial depth image; and
dividing the initial depth image into depth image blocks, performing information compensation between non-adjacent depth image blocks by a Sum-Product Networks model, and acquiring the dense depth image according to the compensated depth image blocks.

15. The computer device of claim 10, wherein performing feature alignment on the first view image and the sparse view image to acquire the feature matrix further comprises:
inputting the first view image and the sparse view image to a pre-trained feature extraction and matching network, extracting a matched coordinate point and a corresponding color value, and combining the matched coordinate point and the corresponding color value into the feature matrix.

16. The computer device of claim 10, wherein a loss function of the neural radiance field comprises at least one of a color loss function, a depth loss function, or a feature-match loss function.

17. The computer device of claim 16, wherein the color loss function is configured to acquire a pixel error between the second view image and the sparse view image, the depth loss function is configured to acquire a difference between a depth value of the second view image and a depth value of the dense depth image, and the feature-match loss function is configured to acquire a difference between a color value of a feature point in the second view image and a color value obtained by querying a coordinate corresponding to the feature point from the feature matrix.

18. A computer device, comprising a memory and a processor, wherein a computer program is stored in the memory, and the processor is configured to execute the computer program to implement the new view image synthesis method of claim 9.

19. A computer-readable storage medium, storing a computer program, wherein the computer program is executed by a processor to implement the neural radiance field training method of claim 1.

20. A computer-readable storage medium, storing a computer program, wherein the computer program is executed by a processor to implement the new view image synthesis method of claim 9.
